(19) United States
(12) Patent Application Publication
(10) Pub. No.: US 2009/0070371 A1
(43) Pub. Date: Mar. 12, 2009

(54) INLINE RIGHTS REQUEST AND COMMUNICATION FOR REMOTE CONTENT

(75) Inventors: Ryan B. Cunningham, San Francisco, CA (US); Chris Kalaboukis, Los Gatos, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/854,369

(22) Filed: Sep. 12, 2007

(51) Int. Cl. G06F 17/00

(52) U.S. Cl. 707/104.1; 707/E17.009

(57) ABSTRACT

Methods for inline communication of permissible uses or rights of a media asset to a user are provided. In one example, a method includes receiving an intended use of a media asset from a remote device (e.g., from a user wishing to reuse the media asset in some fashion), and allowing communication of the media asset if the intended use satisfies a predetermined permissible use set (which may include one or more permissible criteria). The intended use may be compared with the predetermined permissible use set to determine if the use is okay, and if so, the method provides the remote device with a link to the media asset or a source of the media asset. In other examples, the method may transfer the media asset to the remote device, e.g., via a file transfer, streaming, and so on.

### RELATED APPLICATIONS

The present application is related to U.S. patent application Ser. Nos. 11/784,843, 11/784,918, 11/786,016, and 11/786,020, all of which were filed on Apr. 9, 2007, and all of which are hereby incorporated by reference herein in their entirety.

### BACKGROUND

1. Field

The present invention relates generally to systems and methods for the generation of media assets such as video and/or audio assets via a network, such as the Internet or an intranet, and in particular, to systems and methods for automatically creating movies or aggregate media assets based on a set of criteria.

2. Description of Related Art

Currently there exist many different types of media assets in the form of digital files that are transmitted via the Internet. Digital files may contain data representing one or more types of content, including but not limited to, audio, images, and videos. For example, media assets include file formats such as MPEG-1 Audio Layer 3 (“MP3”) for audio, Joint Photographic Experts Group (“JPEG”) for images, Motion Picture Experts Group (“MPEG-2” and “MPEG-4”) for video, Adobe Flash for animations, and executable files.

Such media assets may be viewed via a variety of media players, e.g., via Windows Media Player, RealPlayer, and the like. Further, media assets may be created and edited using applications executing locally on a dedicated computer via Apple's iMovie and FinalCut Pro and Microsoft's MovieMaker. Additionally, web-based media players and edit applications are available. One exemplary web-based editor application includes JumpCut (jumpcut.com), whereby users may search, grab, and edit content, e.g., media assets, into aggregate media assets. For example, a user may search and use a particular video/audio clip or image with a user-generated movie or within a personal page or blog.

Currently, it is generally difficult for users to determine how or where to obtain permission to reuse content that is available on the Web. For example, a user wishing to use a particular media asset in whole or in part in a user-generated compilation, website, or blog may attempt to contact the content owner or creator in order to obtain reuse permissions. Contacting and obtaining permission from a content owner or creator may be a time-consuming and laborious process, which becomes even more complex as media objects are embedded from site to site to site such that in practice it may be difficult to contact the content creator or owner in order to obtain permission.

### SUMMARY

According to one aspect of the present invention, methods for communicating permissible uses or rights of a media asset to a user are provided. In one example, the method includes receiving an intended use of a media asset from a remote device (e.g., from a user wishing to reuse the media asset in some fashion). In one example, the request is made inline within a web browser window or media player (which may include media asset editing functions) of the remote device. The method further includes allowing or causing communication of the media asset if the intended use satisfies a predetermined permissible use set (which may include one or more permissible criteria). The communication may consist of providing the media asset itself or allowing access to the media asset (e.g., via a link to the media asset) per the intended use/permissible use set. In one example, the intended use may be compared with the predetermined permissible use set to determine if the use is okay, and if so, the method provides the remote device with a link to the media asset or a source of the media asset. In other examples, the method may transfer the media asset to the remote device, e.g., via a file transfer, streaming, and so on.

The method may further include receiving and storing the predetermined permissible use set. The permissible use set may be received from a content creator or content owner. Additionally, content information for the content creator or content owner may be stored and used, e.g., in instances where the intended use is not okay per the predetermined permissible use set. For example, the denied or unapproved intended use may be communicated to the media asset creator or owner for potential approval. Further, all received requests and intended uses, whether approved or not, may be tracked and stored.

According to another aspect of the present invention, apparatus for facilitating use rights information of a media asset is provided. In one example, the apparatus includes logic for comparing a received intended use with a stored permissible use set (which may include one or more criteria) and determining if the intended use is allowable. The apparatus further including logic for causing communication of an approval of the intended use based on the comparison (which may consist of providing the media asset or allowing access to the media asset per the intended use/permissible use set).

The apparatus may further comprise logic for displaying an interface (e.g., a form or fields) for input of permissible uses by a content owner and/or intended uses by a user. The apparatus may further cause the permissible use set to be stored locally or remotely, and may cause input or received intended uses to be stored locally or remotely.

In another aspect, a computer-readable medium comprising instructions for generating a media asset is provided. In one example, the instructions may be for causing the method comprising receiving an intended use of a media asset from a remote device (e.g., from a user wishing to reuse the media asset), and allowing communication of the media asset if the intended use satisfies a predetermined permissible use set (which may include one or more permissible criteria), where allowing communication of the media asset may include providing a media asset or access to the media asset per the intended use/permissible use set. In one example, the intended use may be compared with the predetermined permissible use set to determine if the use is okay, and if so, a link to the media asset or a source of the media asset may be provided to the remote device.

The instructions may further cause receiving and storing the predetermined permissible use set. The permissible use set may be received from a content creator or content owner. Additionally, content information for the content creator or content owner may be stored and used, e.g., in instances where the intended use is not okay per the predetermined permissible use set. For example, the denied or unapproved intended use may be communicated to the media asset creator or owner for potential approval. Further, all received requests and intended uses, whether approved or not, may be tracked and stored.

The various aspects and examples of the present inventions are better understood upon consideration of the detailed description below in conjunction with the accompanying drawings and claims.

### BRIEF DESCRIPTION OF THE DRAWINGS

The following drawing figures, which form a part of this application, are illustrative of embodiments, systems, and methods described below and are not meant to limit the scope of the invention in any manner, which scope shall be based on the claims appended hereto.

FIG. 1 illustrates an exemplary environment and data flow for certain aspects of the present invention.

FIGS. 2A and 2B illustrate exemplary content use forms for use of a media asset.

FIG. 3 illustrates an exemplary intended use form for use of a media asset.

FIG. 4 illustrates an exemplary method for uploading a media asset and permissible use information from a content creator/owner.

FIG. 5 illustrates an exemplary method for approving or disapproving a request for a media asset.

FIG. 6 illustrates an exemplary method for viewing and using media assets.

FIG. 7 illustrates an exemplary interface including an inline use or rights request selection for viewing permissible uses and/or inputting intended uses.

FIG. 8 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

According to one aspect of the present invention, a method includes providing a user, e.g., a content consumer, an inline ability to request the use of a media asset for reuse. In one example, the request may include a pop-up form that queries the user and collects the intended reuse of the media. The method further compares the request with a rule set (e.g., a set of permissible uses) that the content creator generated when uploading, storing, or otherwise making the media asset available. If the request passes the rule set, the user may immediately be given a link to download and reuse the content. If the rule set is denied, the form may communicate the request to the content creator who may manually release the rights to the requester or contact the content creator/owner to negotiation a user, price, etc.

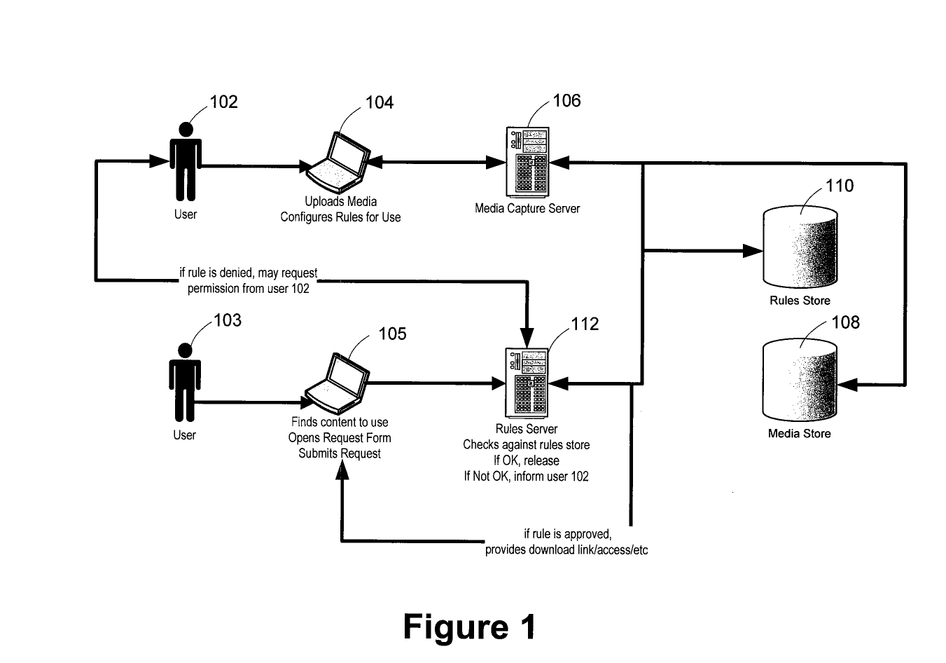

FIG. 1 illustrates an exemplary environment and workflow for uploading media assets and requesting reuse of media assets. User 102, which may include a content creator or content owner, uploads the media asset via user device 104 and media capture server 106 to a remote media store 108.

User 102 may further create or select a rule set (which may include one or more rules) or permissible uses of the media asset by other users. The rule set or permissible use set may be selected via default selections presented to user 102, the rules may be entered to vary based on the user accessing the content (e.g., to vary based on blogger use versus commercial use or the like). The rule set and other associated permission information may then be stored, e.g., in a rules database 110 (which may be local or remote to media store 108). Rules database 110 may include a canonical database.

Additionally, rules database 110 may include contact information regarding the content owner or creator such that in some examples, the system, service provider, or a user may contact the content owner or creator (regarding a request for reuse of a media asset). The contact information may include a preferred method for contact.

User 103, which may include a content user or content consumer, may view various media assets within media store 108 via client device 105 and select content they wish to reuse, e.g., in an aggregate media asset, website, blog, etc. User 103 may select content for reuse in an inline fashion, e.g., by selecting a button displayed with a media player (which may include a media asset editor) such as “use this,” attempting to download the file, and so on. In one example, in response to a request to reuse the media asset a form will be displayed on device 105 for recording the intended use of the media asset. For example, a pop-up window may display for completion by the user. In other examples, a field may be displayed within a media player or browser window. In yet other examples, a user profile or cookie associated with user 103 or client device 105 may be accessed to retrieve information regarding a permissible use set/intended use.

The intended use information is communicated to rule server 112 (which may be remote to or local with other devices such as media capture server 106, rules database 110, and/or media store 108). Rule server 112 compares or checks the intended use(s) input by user 103 against the predetermined permissible use set stored with rule database 110. If the intended use passes the rule set, and is thus approved, user 103 may be given access to the media asset. For example, a link to download or a link to the media asset may be provided to device 105. User 103 may then embed or otherwise include the media asset in their website, for example. In another example, in response to passing the rule set the media asset may transferred via a file transfer or streamed to device 105 or moved to a storage server or account associated with user 103. Accordingly, in this example, the described exemplary workflow and stored permissible use set allows for the release of reuse rights as determined by the content owner/user because permissions can be given nearly immediately if the request meets the predetermined rule criteria without needing to pass the request to the content creator.

In some examples, all requests for media assets are recorded, including whether the request is approved or denied. For example, a log of the request and result of checking the intended use with the rule set may generated and stored (e.g., in rules database 110 or elsewhere). The data may be aggregated over time for use by user 102 (e.g., content owners/creators), user 103 (e.g., content users), network providers, advertisers, and so on. This allows a content owner/creator to be informed when and where a particular media asset is being reused; as well as what intended uses may be in demand.

In one example, if the intended use submitted by user 103 does not pass the stored rule set, rule server 112 causes a communication to user 103 requesting contact information (if not already received or known) in order to inform user 103 if the intended use request may possibly be granted once the content creator has been contacted. For instance, user 102 may be informed, e.g., via an email, text message, phone call, or the like (depending on the contact information provided in the content creator workflow), that a particular intended use request was denied per the stored permissible use set. User 102 may review the submitted intended use and manually release the media asset for reuse, at which point, user 103 may be informed of the approval. In other examples, user 102 and 103 may communicate directly and come to terms for the use of the media asset (e.g., negotiating a use, price, etc.).

As an illustrative example, if user 103 requests to reuse a video and the request either fails the rule set test or part of the rule set requires an approval of user 102, and user 102 has provided a phone number as the primary communication means, then the system may initiate a VOIP call to user 102 and read the request. For example, the request can be read in a VOIP communication as “Fred Thompson wishes to use your clip video7 in a compilation about sharks on the Discovery channel web site, if this is OK please press 1, otherwise hang up.” The content creator can then release the video for reuse by any medium they prefer.

It is noted that a media asset as used here may include, e.g., a video file, audio file, image file, text file, and the like. Further, for purposes of this disclosure, the drawings associated with this disclosure, and the appended claims, an “asset” refers to a logical collection of content that may be comprised within one or more files. For example, an asset may be comprised of a single file (e.g., an MPEG video file) that contains images (e.g., a still frame of video), audio, and video information. As another example, an asset may be comprised of a file (e.g., a JPEG image file) or a collection of files (e.g., JPEG image files) that may be used with other media assets or collectively to render an animation or video. As yet another example, an asset may also comprise an executable file (e.g., an executable vector graphics file, such as an SWF file or an FLA file). A media asset database, library, or store may include many types of assets, including but not limited to, video, images, animations, text, executable files, and audio.

Furthermore, in one example, an exemplary media player system and method allows a user, e.g., user 103, to view and/or edit a low-resolution version of a remotely stored high-resolution media asset (e.g., stored in media store 108 by user 102). Exemplary systems and methods are described in co-pending U.S. patent application Ser. Nos. 11/784,843, 11/784,918, 11/786,016, and 11/786,020, all of which were filed on Apr. 9, 2007, and all of which are hereby incorporated by reference. These are illustrative of particular examples, and it will be understood that other systems and methods for viewing and communicating media assets to and from remote users are possible and contemplated. For example, various known media players and/or web based editor applications may be similarly used with the examples described.

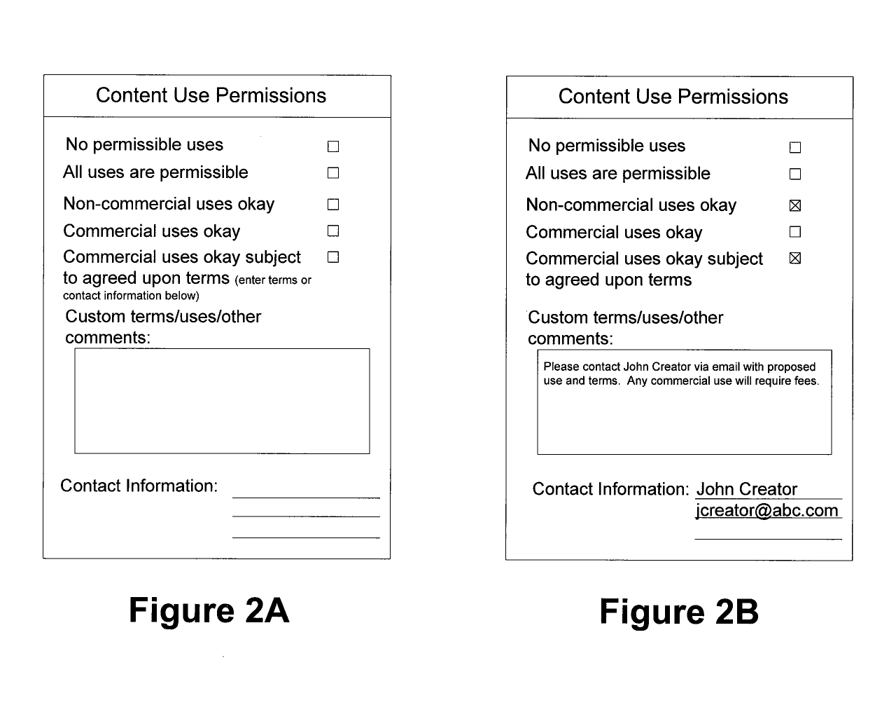

FIGS. 2A and 2B illustrate exemplary content use forms for use of a media asset. For example, a content creator uploading or otherwise associating content uses for a media asset (or group of media assets) may fill out a form as illustrated in FIGS. 2A and 2B. As previously described, in one example, the forms are displayed as a pop-up window or drop-down menu in response to a user uploading or adding a media asset to a media store. Alternatively, the forms may be displayed within a media player, browser window, file transfer/upload window, or the like.

In this example, the content owner may select from various uses, including no permissible uses, all uses are permissible, non-commercial uses okay, commercial uses okay subject to agreed upon terms (which could be specified in the form or negotiated via contacting the owner as illustrated in FIG. 2B), as well as a field for custom terms or uses. The forms further include a field for contact information and preferred contact means, in this example, via email (but include via phone, text message, standard mail, and the like, or combinations thereof).

The information input into the forms may be stored in a database and used as described for determining if a user's intended use passes the permissible use set based on these forms. Additionally, in some examples, a user may select to view use permissions, in which case, a form that has been completed such as that shown in FIG. 2B may be displayed at the user device (but without the contact information, for example). Additionally, the information may be communicated to a user when a media asset is viewed such that an application on the client device, e.g., the media player or browser, may determine if an intended use will satisfy the permissible use set.

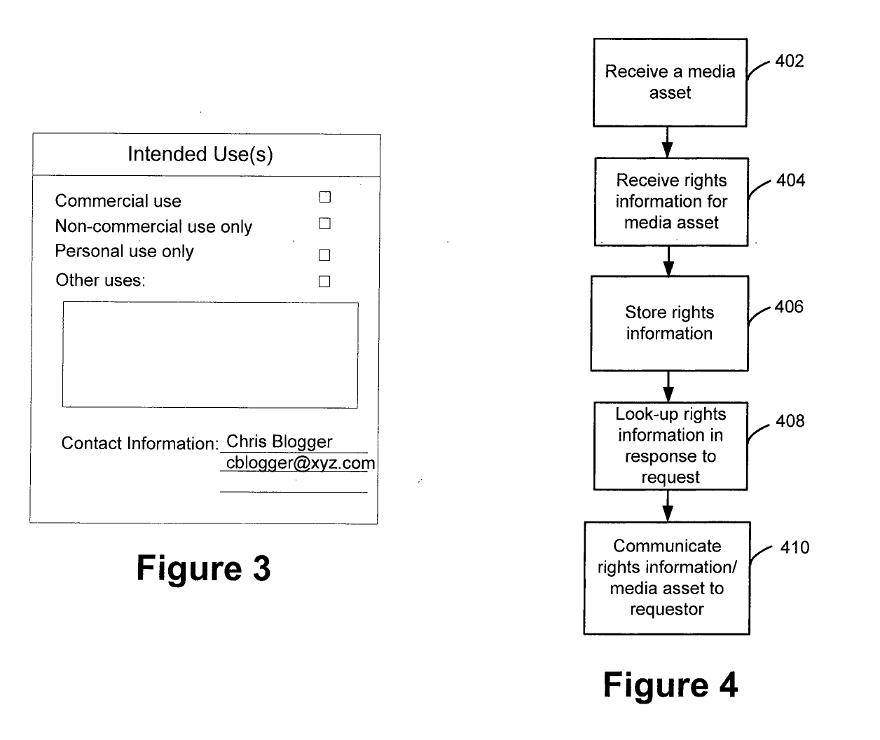

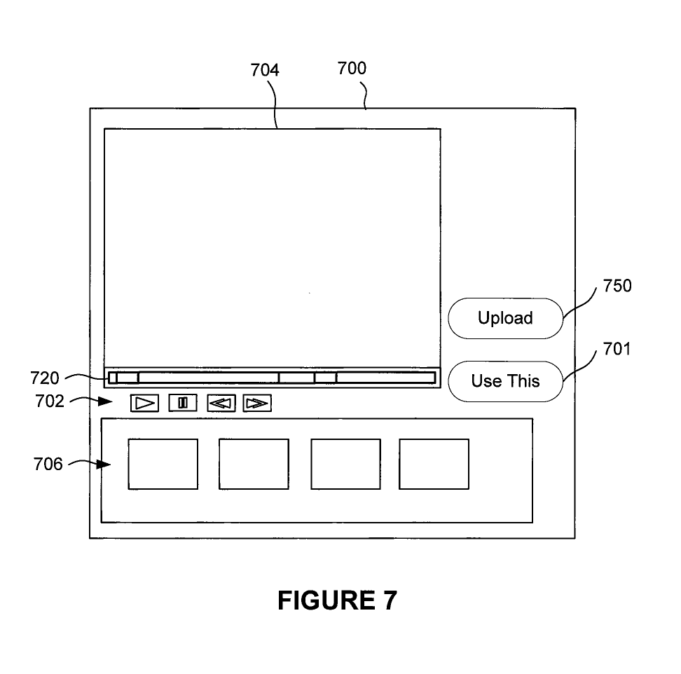

FIG. 3 illustrates an exemplary intended use form associated with a media asset. For example, in response to a user indicating a desire to reuse a media asset or otherwise inquiring regarding the use rights of a media asset the form illustrated may be displayed in a pop-up window. For example, as described below with reference to FIG. 7, a media player (and/or media editor) may be equipped with a “reuse” button that may cause the inline display of the form illustrated in FIG. 3. In other examples, the form may be displayed as a drop-down menu or fields within a media player or browser window. The input information may then be used to check or compare against previously input content use permissions by a backend server, e.g., a media server, rules server, or other device associated with a media service provider. Additionally, in some examples, the user may input contact information, which may be used if the use is denied, but the content owner nevertheless wishes to contact the user.

It will be understood that the permissible use set and intended uses are illustrative only and may vary. For example, the set may vary for the type of media asset it is associated with. Further, the set of permissible uses may include a single selectable criterion or any number of selectable criteria. Additionally, different sets of permissible uses may be associated with a single media asset, e.g., where a first set is used for a first category of user (e.g., a blogger or website owner) and a second set is used for a second category of user (e.g., a user creating compilation media assets).

FIG. 4 illustrates an exemplary method for receiving a media asset and permissible use information from a user, e.g., a content creator/owner. In one example, the method includes receiving a media asset in block 402. For instance, a system (e.g., a server device or service provider network) receives a media asset from a user and stores the media asset within a media asset database or store. The media asset may be uploaded from a remote device via a browser application, media player, or upload application.

The method further includes receiving a permissible use set for reuse of the media asset in block 404 and storing the set in block 406. The permissible use set may be input via a form as described with respect to FIG. 3. The set of permissible uses may be stored locally or remotely to a device that receives the media asset and/or permissible use set. Further, the media assets may be stored with a separate service provider.

The method further includes looking-up or accessing the permissible set of uses in response to a request to reuse the media asset or inquiry of permissible uses in block 408. In one example, the system receives a set of intended uses and causes the intended use set to be compared to the permissible use set previously stored. If the intended uses are included in the permissible use set (or are acceptable in light of the permissible use set) the request to reuse the media asset may be approved and the media asset or a link to the media asset communicated to the user at 410. If the intended uses are not included in the permissible use set the request may be denied and the denial communicated to the user.

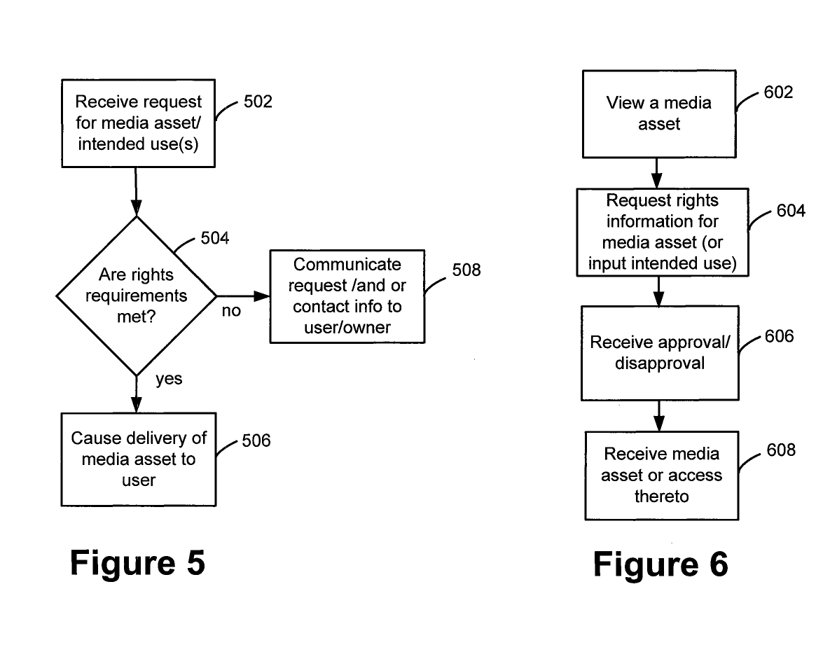

FIG. 5 illustrates an exemplary method for approving or disapproving a request for a media asset. In one example, the method includes receiving a request for a media asset or a request for permissible uses of a media asset in block 502. For example, a server device may receive the request from a remote device, such as a client device. The server device may be the same or different from a server device that initially received the media asset and/or permissible use set as described with respect to FIG. 4.

The method further includes determining if the permissible use set requirements are met at block 504. For example, the method determining if the intended uses are included in or pass the permissible use set or are otherwise acceptable based on the stored permissible use set. In one example, the server device retrieves the permissible use set and compares to the received intended use to determine if allowed. In other examples, the server may communicate the intended use to a local or remote device for comparison of the intended use against the permissible use set and receives a communication indicating if allowed or not.

If the intended use passes the permissible use set, the method causes the delivery of the media asset to the user or provides access to the media asset by the user at block 506. For example, the server device may communicate a link to the source of the media asset or the media asset itself. If the intended use fails to pass the permissible use set at block 504, the request and intended uses may be communicated to the media asset owner for further consideration at block 508. For example, a media asset owner may contact the requester and approve the request or negotiate the intended use terms (e.g., negotiate the uses, price, and so on).

FIG. 6 illustrates an exemplary method for viewing and using media assets. In this example, the method includes viewing a media asset in block 602. For example, a user may browse various media assets via a media player or a browser application. The method further includes requesting the media asset or requesting to communicate intended uses at block 604, which may prompt a user for intended use information. For example, an exemplary media player 700 is illustrated in FIG. 7 and may be equipped with a “use this” button 701, which when selected may display a form similar to that of FIG. 3 for entering intended use information and/or contact information.

The method further includes receiving approval or disapproval regarding the requested use and intended use at block 606. In some examples, the method may include receiving a listing or portion of the permissible rights associated with the media asset at block 606. If the intended use is approved (or denied and then agreed upon by the content owner), the method further includes receiving the media asset or receiving access to the media asset at block 608. For example, the media asset may be received through a file transfer, streaming feed, link to the media asset, link to a source of the media asset, or the like.

The various methods described and shown may be carried out by any combination of software, hardware, or firmware. In one example, the exemplary methods comprise computer-implemented methods, which may be carried out by software operating on one or more computing devices, e.g., a server device, client device, and the like. Further, various methods may be carried out in orders other than those shown in the blocks, and in some instances one or more blocks may be carried out at least partially in parallel.

FIG. 7 illustrates an exemplary interface 700 including an inline rights request selection button 701 for requesting use of a media asset, viewing permissible uses, and/or inputting intended uses. Interface 700 may include a media player having editing functions as described, for example, in co-pending U.S. patent application Ser. Nos. 11/784,843, 11/784,918, 11/786,016, and 11/786,020, all of which were filed on Apr. 9, 2007, and all of which are hereby incorporated by reference. In other examples, however, interface 700 may include only play functionality for displaying media assets. Further, interface 700 may be a stand alone window displayed on a remote device, e.g., a client device, or embedded within a browser window of a client device.

In this illustrative example, interface 700 includes a display portion 704 for displaying media assets and a control portion 702 which may include various controls (such as play, stop, pause, etc.). Additionally, interface 700 may include a timeline 720 associated with the displayed media asset. Interface 700 may further include various other features such a search interface for searching for media assets in an on-line client-server architecture as described, as well as with other local or remote stores. In examples where interface 700 includes editing functions, a plurality of tiles associated with different media assets, e.g., video clips, may be displayed in display portion 706. Each tile may be associated with different media assets used in an aggregate media asset or for editing a media asset as described more fully in the aforementioned applications incorporated by reference herein. Various other controls and features for a media editor may be included and are contemplated.

Interface 700 may display a media asset, and in one example, a low-resolution version of a remotely stored high-resolution media asset in display portion 704. A user, desiring to reuse the media asset or otherwise obtain use rights, may select button 701. In one example, a pop-up window including a form as illustrated in FIG. 3 may be displayed on the user device. In other examples, a drop down menu or fields may be displayed within interface 700 or a browser window associated with interface 700 or a device for inputting intended uses.

User interface 700 may further include an “Upload” button 750, which switches to or launches an interface for uploading media objects to a remote storage. For example, to upload locally stored media assets to a remote media asset library a user may select button 750 to launch an upload application or window. Additionally, in response to selection of button 750 a window or form may be displayed for entering the permissible uses of the media asset by other users, the form similar or identical to that shown in FIGS. 2A and 2B.

It will be understood that user interface 700 is one specific example of a user interface for viewing and/or editing media assets, which may be embedded within a browser window, and various other media players having different functionalities and appearances may be used. For example, a media player could include functions not described here as well as fewer functions than described here.

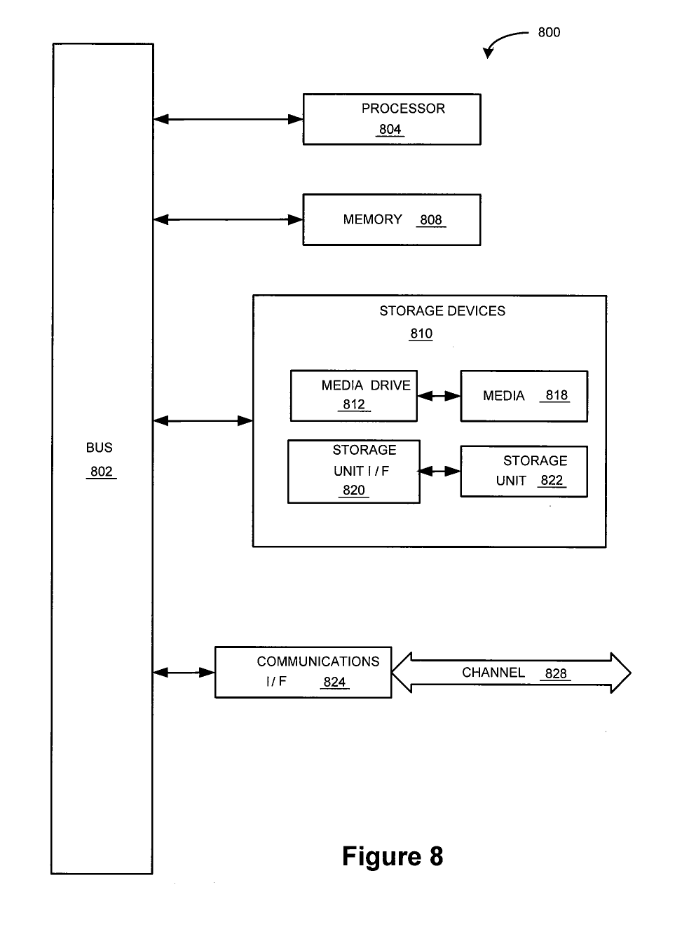

FIG. 8 illustrates an exemplary computing system 800 that may be employed to implement processing functionality for various aspects of the invention (e.g., as a user/client device, media server, media capture server, media rules server, rules store, media asset library, activity data logic/database, combinations thereof, and the like.). Those skilled in the relevant art will also recognize how to implement the invention using other computer systems or architectures. Computing system 800 may represent, for example, a user device such as a desktop, mobile phone, personal entertainment device, DVR, and so on, a mainframe, server, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, preferably random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus 802 for storing static information and instructions for processor 804.

The computing system 800 may also include information storage mechanism 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818 may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage mechanism 810 may include other similar instrumentalities for allowing computer programs or other instructions or data to be loaded into computing system 800. Such instrumentalities may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical, or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 808, storage device 818, storage unit 822, or signal(s) on channel 828. These and other forms of computer-readable media may be involved in providing one or more sequences of one or more instructions to processor 804 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for inline communication of permissible uses of a media asset, the method comprising:
receiving an intended use of a media asset from a remote device; and
allowing a communication of at least a portion of the media asset to the remote device if the intended use satisfies a predetermined permissible use set.

2. The method of claim 1, further comprising receiving and storing the predetermined permissible use set.

3. The method of claim 1, wherein the received intended use was input inline via a browser or media player application.

4. The method of claim 1, further comprising causing a comparison of the intended use with a predetermined permissible use set to determine if the intended use is allowable.

5. The method of claim 1, wherein the intended use comprises a request to download the media asset.

6. The method of claim 1, wherein the intended use comprises user input to a displayed form associated with a media player.

7. The method of claim 1, further comprising causing the display of the media asset with a media player.

8. The method of claim 1, further comprising causing at least a portion of the permissible use set for the media asset to be communicated to the remote device.

9. The method of claim 1, wherein the allowing a communication comprises communicating a link to the media asset to the remote device.

10. The method of claim 1, wherein if the intended use is not allowable according to the predetermined permissible use set, further comprising communicating the intended use to an owner of the media asset.

11. Apparatus for communicating inline use rights information of a media asset, the apparatus comprising:
logic for receiving an intended use of a media asset from a remote device;
logic for causing a comparison of a received intended use with a stored permissible use set and determining if the intended use is allowable; and
logic for causing communication of an approval of the intended use based on the comparison.

12. The apparatus of claim 11, further comprising logic for receiving and storing the predetermined permissible use set.

13. The apparatus of claim 11, wherein the intended use comprises a request to download the media asset.

14. The apparatus of claim 11, wherein the intended use comprises user input to a displayed form associated with a media player.

15. The apparatus of claim 11, further comprising logic for causing at least a portion of the permissible use set for the media asset to be communicated to the remote device.

16. The apparatus of claim 11, wherein the approval comprises communicating the media asset to the remote device.

17. The apparatus of claim 11, wherein the approval comprises communicating a link to the media asset to the remote device.

18. The apparatus of claim 11, wherein if the intended use is not allowable according to the predetermined permissible use set, further comprising logic for communicating the intended use to an owner of the media asset.

19. A computer-readable medium comprising instructions for inline communication of permissible uses of a media asset, the instructions for causing:
receiving an intended use of a media asset from a remote device; and
allowing a communication of at least a portion of the media asset if the intended use satisfies a predetermined permissible use set.

20. The computer-readable medium of claim 19, the instructions further for causing receiving and storing the predetermined permissible use set.

21. The computer-readable medium of claim 19, the instructions further for causing the display of a form with the remote device for inputting the intended use.

22. The computer-readable medium of claim 19, the instructions further for causing a comparison of the intended use with a predetermined permissible use set to determine if the intended use is allowable.

23. The computer-readable medium of claim 19, wherein the intended use comprises a request to download the media asset.

24. The computer-readable medium of claim 19, wherein the intended use comprises user input to a displayed form associated with a media player.

25. The computer-readable medium of claim 19, the instructions further for causing a display of the media asset with a media player.

26. The computer-readable medium of claim 19, the instructions further for causing at least a portion of the permissible use set for the media asset to be communicated to the remote device.

27. The computer-readable medium of claim 19, wherein allowing a communication comprises communicating a link to the media asset to the remote device.

28. The computer-readable medium of claim 19, wherein if the intended use is not allowable according to the predetermined permissible use set, further comprising communicating the intended use to an owner of the media asset.
